(19) United States
(12) Patent Application Publication
(10) Pub. No.: US 2020/0171335 A1
(43) Pub. Date: Jun. 4, 2020

(54) Local neutralizer for strong acid and strong base contamination

(71) Applicant: Stephen Knight, Oklahoma City, OK (US)

(72) Inventor: Stephen Knight, Oklahoma City, OK (US)

(21) Appl. No.: 16/602,451

(22) Filed: Oct. 8, 2019

Related U.S. Application Data
(60) Provisional application No. 62/917,335, filed on Dec. 3, 2018.

(51) Int. Cl. A62D 3/37

(52) U.S. Cl. CPC A62D 3/37; A62D 2101/20; A62D 2203/10

(57) ABSTRACT

A local neutralizing device for strong acid or strong base accidental environmental contamination is provided in the form of a compressed canister with a content distribution means which is portable and target control specific by a user to dispense a weak base to a strong acid accident location to neutralize the strong acid, or alternatively to dispense a weak acid to a strong base accident location to neutralize the strong base, either alternative intended to reduce, contain, neutralize and assist in the remediation of the accidental spill.

### CROSS REFERENCE TO RELATED APPLICATIONS

Applicant claims the benefit of Provisional Patent Application No. 62/917,335, filed by the same inventor on Dec. 3, 2018.

### I. BACKGROUND OF THE INVENTION

### 1. Field of Invention

A local neutralizing device for strong acid or strong base accidental environmental contamination is provided in the form of a compressed canister with a content distribution means which is portable and target control specific by a user to dispense a weak base to a strong acid accident location to neutralize the strong acid, or alternatively to dispense a weak acid to a strong base accident location to neutralize the strong base, either alternative intended to reduce, contain, neutralize and assist in the remediation of the accidental spill.

### 2. Description of Prior Art

A preliminary review of prior art patents was conducted by the applicant which reveal prior art patents in a similar field or having similar use. However, the prior art inventions do not disclose the same or similar elements as the present neutralizer for strong acids or bases, nor do they present the material components in a manner contemplated or anticipated in the prior art.

In U.S. Pat. No. 7,722,830 to Kimura, discloses a system for decomposing organic compounds, whether liquid or gas, using an ultraviolet decomposition unit to treat polluted liquids and gasses by the addition of strong acid or strong base electrolytic water to the polluted liquid or gas containing the pollution. In U.S. Pat. No. 5,457,243 to Knifton, removal of organic acids from a crude methyl tertiary butyl ether (MTBE) stream of a reactor to treat the MTBE.

There are other products on the market that are granular or liquid which are poured on organic acid spills to neutralize them, most commonly by dispensing the dry or liquid neutralizers on the spill, allowing time for absorption and then sweeping up or vacuuming the neutralized materials and disposing of the neutralized materials. None of the prior art devices or materials provide a compressed content canister having a weak acid foaming material to neutralize strong base contamination and a compressed content canister having a weak base foaming material to neutralize strong acid contamination.

### II. SUMMARY OF THE INVENTION

Spills of hazardous acids and bases must be absorbed, neutralized or controlled at the time of the incident in order to maintain workplace safety. Neutralization helps make spilled materials safer to handle and helps decrease the cost of disposal. In industry, strong acids and strong bases are used for manufacturing, oil field production enhancement, product manufacturing, pore processing and several other industrial applications. Strong acids include hydrochloric acid, hydrofluoric acid, nitric acid, sulfuric acid, hydrobromic acid, hydriodic acid, perchloric acid and chloric acid, generally having a pH below 4. They are delivered in various strength concentrations and are dangerous to both organic and inorganic surroundings, especially to people, plants and animals. Strong bases include ammonium hydroxide, potassium hydroxide and sodium hydroxide, which are easily as damaging and deadly as strong acids.

Neutralization remediation can be safety performed by adding a weak acid to a strong base spill, by the addition of a weak base to a strong acid, and subsequently the dissolution by water, bring the mixture as close to a 7 pH level prior to evacuation and elimination of the now neutralized solution of remnant sludge mixture. Disposal is performed of the safe level sludge, which reduce any environmental impact upon an environmental disposal site.

The present portable neutralizing device provides a compressed portable container providing a weak base in powder, liquid or foam to neutralize a strong acid spill, and also alternatively provides a weak acid in powder, liquid or foam to neutralize a strong base spill, creating a safe pH level sludge which can be evacuated and eliminated from an environment with nominal risk to the person handling the elimination and also reducing the risk to the environment in an immediate and safe manner.

### III. DESCRIPTION OF THE DRAWINGS

There are no drawings accompanying this patent application.

### IV. DESCRIPTION OF THE PREFERRED EMBODIMENT

Chemical spill can pose a danger to people, plants, animals and the environment in general. These accidental spills generally occur in commercial or industrial settings and occurs due to spills, leaks or mishandling of the various products. Those that involve solid or liquid chemical spills should be neutralized for safe handling before eliminating the product to reduce the impact of the hazardous material and also to make the material safer to handle and dramatically reduce the disposal cost. Primarily, the present portable a local neutralizing device provides for neutralization of various hazardous chemical spills in dry or liquid form that poses danger to persons and to the local environment in a charged compressed content dispensing device with a directional neutralizer spray means, dispensing a neutralizing agent appropriate for the hazardous chemical neutralization.

The local neutralizing device comprises a vessel which is charged with a neutralizing agent and a pressurized gas which may be pressurized air. A hose or tube is defines a first end attached to the vessel which integrates with the vessel contents and expels the contents of the vessel, which is a mixture of the compressed gas and neutralizing agent with a nozzle attached to the hose's second end to direct the compressed gas and neutralizing agent to an intentional location for remediation and neutralization of a contaminant. It would be provided as a hand-held portable device that can be located at an accessible position within a workplace, with prominent lettering to indicate the intended use for the contents of the device, and perhaps colorized in the event there are multiple devices in a single location. The devices should also be anchored within the workplace with some type of quick release means to disengage an anchoring means. The lack of drawings in intentional, as the device is most likely designed in the same manner and size as a portable fire extinguisher. The distinctive nature of this patent subject matter lies within the contents and use of the local neutralizing device.

There are three hazardous chemicals that will be addressed by the local neutralizing device. A first embodiment is directed to the neutralization of a strong acid. A second embodiment is directed to neutralization of a strong base. A third embodiment is directed to other hazardous organic material spills. The basic principal behind the chemical neutralizing device and its contents is the use of a weak acid to neutralize a strong base, a weak base to neutralize a strong acid, and an absorbent dry substrate to neutralize an organic liquid spill. Each embodiment is directed to neutralize the target substance and make it safe for handling and disposal.

The term neutralization is used for a reaction between an acid and base or alkali. Historically, this reaction was represented as

acid+base→salt+water

For example:

HCl+NaOH→NaCl+H₂O

The statement is still valid as long as it is understood that in an aqueous solution the substances involved are subject tO disassociation, which changes the substances ionization state. The arrow sign, →, is used because the reaction is complete, that is, neutralization is a quantitative reaction. A more general definition is based on Bronsted-Lowry acid-base theory:

AH+B→A+BH

Electrical charges are omitted from generic expressions such as this, as each species A, AH, B, or BH may or may not carry an electrical charge. Neutralization of sulphuric acid, provides a specific example. Two partial neutralization reactions are possible in this instance.

H₂SO₄+OH⁻→HSO₄—+H₂O

HSO₄-+OH⁻→SO₄2—+H₂O

Overall: H₂SO₄+2OH⁻→SO₄2—+2H₂O

The same equation relating the concentrations of acid and base applies. The concept of neutralization is not limited to reactions in solution. For example, the reaction of limestone with acid such as sulfuric acid is also a neutralization reaction.

[Ca,Mg]CO₃(s)+H₂SO₄(aq)→(Ca²⁺,Mg²⁺)(aq)+SO₄2−(aq)+CO₂(g)+H₂O

Strong acids that are commonly used in the commercial and industrial setting include hydrochloric acid, hydrofluoric acid, acetic acid, nitric acid, per4chloric acid, phosphoric acid and sulfuric acid and other chemicals having a pH of less than 4. Strong bases include lithium hydroxide, calcium hydroxide, ammonium hydroxide, potassium hydroxide and sodium hydroxide and other chemicals having a pH of greater than 10. Organic materials are most numerous and include acetone, benzene, ethylene glycol, formaldehyde, methylene chloride, perchoroethylene, toluene, xylene, TCE, PCB, and other chlorinated solvent or solution.

In the first embodiment, providing the device with a neutralizing agent for a strong acid, the device contains a foaming, dry or liquid neutralizer which chemically raises the pH of the strong acid and absorbs the liquid or dry strong acid materials. In the first embodiment the neutralizing agent for the strong acid is selected from a list including but not limited to lime and/or limestone (calcium hydroxide or calcium oxide), soda ash, magnesium hydroxide, baking soda or sodium bicarbonate, or any other elevated pH dry weak basic substance that will not cause a violent neutralization reaction, but will eventually raise the pH of the strong acid to a pH near 7. The completion of the neutralization is generally observable when the strong acid and neutralizing agent stop bubbling or foaming. Upon reaching neutralization, the neutralized material should be able to be swept up and placed in a waste container marked hazardous material and transported to a waste disposal site for proper disposal.

In the second embodiment, providing the device with a neutralizing agent for a strong base, the device contains a foaming, dry or liquid neutralizer which chemically lowers the pH of the strong base and absorbs the liquid or dry strong base materials. In the second embodiment, the neutralizing agent for the strong base is selected from a list including but not limited to weak acetic acid, boric acid, weak muriatic (hydrochloric) acid, citric acid, or any other weak acidic substance that will not cause a violent neutralization reaction, but will eventually lower the pH of the strong base to a pH near 7. Again, completion of the neutralization is generally observable when the strong base and neutralizing agent stop bubbling or foaming. Upon reaching neutralization, the neutralized material should be able to be swept up and placed in a waste container marked hazardous material and transported to a waste disposal site for proper disposal.

In the third embodiment, providing the device with a neutralizing agent for an organic hazardous material, the device contains a foaming, dry or liquid neutralizer which chemically absorbs and reacts with the organic substance to perform a reduction of the hazardous organic materials for disposal or transfer for further treatment at an approved treatment location. The reduction material is selected from a material including vermiculite, gypsum, treated sawdust, iron oxide, iron sulfide or sulfite (especially where the organic material is a chlorinated solvent), or other environmentally inert absorbent material which will perform a chemical reduction of the hazardous nature of the organic substance for containment, disposal or transport to a further chemical treatment facility.

The chemical term “reduction” was originally derived from the chemistry of smelting metal ores. Ores are chemical compounds of metal atoms coupled with other materials. As the ores are smelted to the pure element, the weight of the pure metal are reduced compared with the weight of the ore. Chemically, the positively charged metal ions receive electrons to become the electrically neutral pure metal. Chemists generalized the term “reduction” to any chemical reaction that added electrons to an element. In a similar manner, the chemical reaction of pure metals with oxygen results in the removal of electrons from the neutral metal to produce an oxide. Chemists have generalized the term “oxidation” to refer to any chemical reaction that removes electrons from a material. For a material to be reduced, some other material must be oxidized. The electrons required for microbial reduction of chlorinated solvents in ground water are extracted from native organic matter, from other contaminants such as the benzene, toluene, ethylene and xylene compounds released from fuel spills, from volatile fatty acids in landfill leachate or from hydrogen produced by the fermentation of these materials. The electrons pass through a complex series of biochemical reactions that support the growth and function of the microorganisms that carry out the process.

To function, the microorganisms must pass the electrons used in their metabolism to some electron acceptor. This ultimate electron acceptor can be dissolved oxygen, dissolved nitrate, oxidized minerals in the aquifer, dissolved sulfate, a dissolved chlorinated solvent or carbon dioxide. Important oxidized minerals used as electron acceptors include iron and manganese. Oxygen is reduced to water, nitrate to nitrogen gas or ammonia, iron (III) or ferric iron to iron (II) or ferrous iron, manganese (IV) to manganese (II), sulfate to sulfide ion, chlorinated solvents to a compound with one less chlorine atom and carbon dioxide to methane. These processes are referred to as aerobic respiration, nitrate reduction, iron and manganese reduction, sulfate reduction, reductive dechlorination and methanogenesis, respectively.

The neutralizing agent may be provided as a viscous liquid, a foam product or a dry material, all physical forms having certain benefits in contamination abatement. There are three desired remediation characteristics which are optimally desired by use of the neutralizing agent and dispensing devices. First, there is the desire for containment. Preferably, the device and neutralizing agent would be sprayed around the perimeter of the contaminant to prevent the spread of the contaminant to create a border. As the contaminant attempts to move through the neutralizing agent, it is neutralized by contact. A third desire is for absorption, wherein the contaminant is physically changed into a product which is either non-liquid or a thickened neutral composition which can be vacuumed, mopped or swept into a containment vessel for disposal or site removal. A third desire is for neutralization, which occurs during and after containment, to completely saturate the contaminant to render it harmless and safer to conduct disposal. If those three desire aspects occur during use of the dispensing product and neutralizing agent, then the device has performed with optimal success. If it falls short of all three desired aspects, the contaminant is still less dangerous than it was before remote application of the neutralizing agent over other products currently on the market, where the application is by scooping powder or pouring a liquid product on the contaminant within close proximity to the contaminant.

It is also contemplated that a method and process may be associated with the provision of the local and portable neutralization and reduction device involving the manufacture, distribution and use of the device in the industrial, commercial and private sectors. Although the embodiments of the reduction and local neutralization device and neutralizing agent have been described and shown above, it will be appreciated by those skilled in the art that numerous modifications may be made therein without departing from the scope of the invention as herein described.

1. The local contamination neutralizing device comprising:
a vessel which is charged with a neutralizing agent and a pressurized gas;
a hose defining a first end attached to said vessel which integrating with said pressurized gas and neutralizing agent mixture; and
a nozzle attached to a second end of said hose to expel said compressed gas and neutralizing agent to a contaminant for remediation and neutralization of said contaminant.

2. The local contamination neutralizing device of claim 1, providing the device with a neutralizing agent for neutralizing a strong acid, said local contamination neutralizing device further comprising:
said neutralizing agent is a foaming, dry or liquid neutralizer which chemically raises the pH of said strong acid and absorbs a liquid or dry strong acid contaminant, said neutralizing agent selected from a list including lime, limestone a/k/a calcium hydroxide or calcium oxide, soda ash, magnesium hydroxide, baking soda or sodium bicarbonate, or any other elevated pH dry weak basic substance that will avoid a violent neutralization reaction, but will raise the pH of the strong acid to a pH near 7 in a controlled reaction, wherein subsequent to said neutralization reaction, the remnants of said neutralization reaction can be swept up and placed in a waste container marked hazardous material and transported to a waste disposal site for disposal.

3. The local contamination neutralizing device of claim 1, providing the device with a neutralizing agent for neutralizing a strong base, said local contamination neutralizing device further comprising:
said neutralizing agent is a foaming, dry or liquid neutralizer which chemically lowers the pH of said strong base and absorbs a liquid or dry strong base contaminant, said neutralizing agent selected from a list including weak acetic acid, boric acid, weak muriatic (hydrochloric) acid, citric acid, or any other weak acidic substance that will not cause a violent neutralization reaction, but will eventually lower the pH of the strong base to a pH near 7, wherein subsequent to said neutralization reaction, the remnants of said neutralization reaction can be swept up and placed in a waste container marked hazardous material and transported to a waste disposal site for disposal.

4. The local contamination neutralizing device of claim 1, providing the device with a neutralizing agent for chemical reduction of a hazardous organic contaminant, said local contamination neutralizing device further comprising:
a foaming, dry or liquid neutralizer which chemically absorbs and reduces said organic substance to chemically reduce said hazardous organic materials for disposal or transfer for further treatment at an approved chemical treatment and disposal location, said neutralizing agent being a reduction material selected from a list of chemical reduction materials including vermiculite, gypsum, treated sawdust, iron oxide, iron sulfide or sulfite, especially where the organic material is a chlorinated solvent, or other environmentally inert absorbent material have the chemical property to perform chemical reduction of said hazardous organic contaminant.
